(19) United States
(12) Patent Application Publication
(10) Pub. No.: US 2007/0285346 A1
(43) Pub. Date: Dec. 13, 2007

(54) HEAD MOUNTED DISPLAY AND IMAGE ADJUSTMENT METHOD FOR THE SAME

(75) Inventor: Kuo Yuin Li, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX DISPLAY, INC., TAINAN COUNTY (TW)

(21) Appl. No.: 11/759,097

(22) Filed: Jun. 6, 2007

(30) Foreign Application Priority Data
Jun. 7, 2006 (TW) 095120169

(51) Int. Cl. G09G 5/00

(52) U.S. Cl. 345/8

(57) ABSTRACT

A head mounted display including a frame wearable on a user's head, first and second imaging apparatuses integrating on the frame and at least one control unit. Each imaging apparatus includes a display unit having a plurality of pixels arranged in matrix. The control unit is utilized for selectively setting a part of the pixels as display pixels and the rest of the pixels as non-display pixels, thereby determining the positions of display areas on the display units. Two virtual images respectively seen by a user can be adjusted to substantially coincide with each other by scrolling the positions of the display areas on the display units. The present invention also provides an image adjustment method for the head mounted display.

### CROSS REFERENCE TO RELATED APPLICATION

This application claims the priority benefit of Taiwan Patent Application Serial Number 095120169, filed on Jun. 7, 2006, the full disclosure of which is incorporated herein by reference.

### BACKGROUND OF THE INVENTION

1. Field of the Invention

This invention generally relates to a head mounted display, and more particularly, to a head mounted display and an image adjustment method for the same wherein the image adjustment is implemented by circuit designs.

2. Description of the Related Art

A conventional binocular head-mounted display 80 includes two image displays and can respectively form two virtual images LI and RI in front of two eyes of a user 90, as shown in FIG. 1a, wherein LI represents the virtual image formed in front of the left eye of the user 90 and RI represents the virtual image formed in front of the right eye of the user 90, and the two virtual images LI and RI together form a combined virtual image to be seen by the user 90. For the existence of the manufacturing tolerances of mechanisms and optical elements, e.g. a reasonable manufacturing tolerance of a mechanism is generally larger than 0.05 mm, dipvergence and convergence may exist between the virtual images LI and RI formed in front of two eyes of the user 90, as shown in FIG. 1b. Although human eyes have the ability to automatically correct two virtual images LI and RI which are within an acceptable tolerance range to substantially coincide with each other such that only one combined virtual image will be seen by the user. However, when the user 90 utilizes an uncorrected head-mounted display to see images for a long period of time, it may cause a burden to the eyes thereby introducing amblyopia, headache and nausea etc. In order to solve the dipvergence and convergence problems existing in the conventional head-mounted display, presently makers have to manufacture molds with much higher precision, or they have to dispose additional mechanical adjusting mechanisms on the binocular head-mounted display 80 so as to adjust positions of the virtual images LI and RI formed in front of two eyes of the user 90. However, the additional mechanical adjusting mechanisms may not only increase the total weight and the complexity of the optical engine thereby causing burden and inconvenience to the user 90 while using the product, but also increase the manufacturing cost of the same.

According to the above reasons, it is necessary to improve the conventional binocular head-mounted display and image adjustment method for the same so as to solve the problems existing in the art.

### SUMMARY OF THE INVENTION

It is an object of the present invention to provide a head mounted display and an image adjustment method for the same of which the position adjustment of the virtual images is implemented by circuit designs so as to simplify the structure complexity and decrease the manufacturing cost of the head mounted display.

It is another object of the present invention to provide a head mounted display and an image adjustment method for the same, wherein the head mounted display has a plurality of pixels arranged in matrix and the number of the total pixels is larger than that of the pixels actually utilized for displaying a picture, thereby the display area can be adjusted by scrolling so as to simplify image adjustment procedure.

It is a further object of the present invention to provide a head mounted display and an image adjustment method for the same, wherein the convergence angle of two virtual images seen by two eyes of a user can be adjusted by scrolling so as to increase comfort for using the head mounted display.

In order to achieve above objects, a head mounted display according to the present invention mainly includes a frame wearable on a user's head, first and second imaging apparatuses for respectively integrating on the frame and at least one control unit. The first and the second imaging apparatuses respectively include a display unit having a plurality of pixels arranged in matrix, and the control unit is utilized for selectively setting a part of the pixels as display pixels and the rest of the pixels as non-display pixels, thereby determining the positions of display areas on the display units.

The present invention further provides an image adjustment method for a head mounted display comprising the steps of: providing a first imaging apparatus having a plurality of pixels arranged in matrix for generating a first virtual image; providing a second imaging apparatus having a plurality of pixels arranged in matrix for generating a second virtual image; and selectively setting a part of the pixels as display pixels and the rest of the pixels as non-display pixels, thereby respectively determining the positions of display areas on the first and the second imaging apparatuses.

### BRIEF DESCRIPTION OF THE DRAWINGS

Other objects, advantages, and novel features of the present invention will become more apparent from the following detailed description when taken in conjunction with the accompanying drawings.

FIG. 1a shows a schematic diagram of a conventional head mounted display, which forms two virtue images in front of two eyes of a user by.

FIG. 1b shows a schematic diagram of the virtue images seen by a user by using a conventional head mounted display.

FIG. 2 shows a schematic diagram of a head mounted display according to one embodiment of the present invention.

FIG. 3a shows a schematic diagram of a display area on a display unit of the head mounted display according to the embodiment of the present invention.

FIG. 3b shows a schematic diagram of a display area on a display unit of the head mounted display according to the embodiment of the present invention, wherein the display area is moved upward by scrolling.

FIG. 3c shows a schematic diagram of a display area on a display unit of the head mounted display according to the embodiment of the present invention, wherein the display area is moved rightward by scrolling.

FIG. 4a shows a schematic diagram of the virtue images seen by a user wherein one of the images is adjusted to move rightward by utilizing the head mounted display according to the embodiment of the present invention.

FIG. 4b shows a schematic diagram of the virtue image seen by a user wherein the other one of the images is adjusted to move downward by utilizing the head mounted display according to the embodiment of the present invention.

FIG. 4c show a schematic diagram of the virtue images seen by a user wherein the two images have been adjusted to substantially coincide with each other by utilizing the head mounted display according to the embodiment of the present invention.

FIG. 5a shows a schematic diagram of the virtue images seen by a user wherein the virtual image plane of the images is not yet adjusted by utilizing the head mounted display according to the embodiment of the present invention.

FIG. 5b shows a schematic diagram of the virtue images seen by a user wherein the virtual image plane has been adjusted by utilizing the head mounted display according to the embodiment of the present invention.

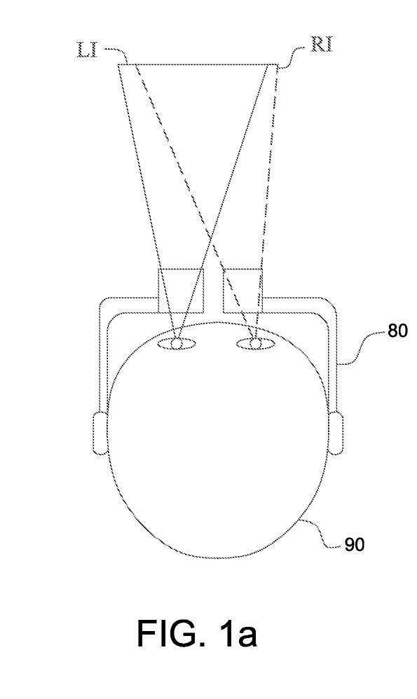

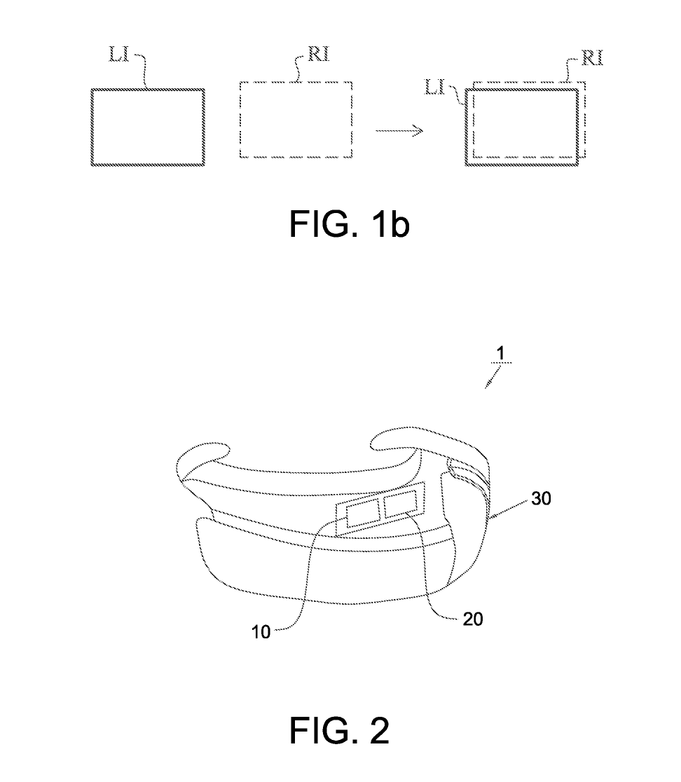

### DETAILED DESCRIPTION OF THE PREFERRED EMBODIMENT

Referring now in detail to exemplary embodiments of the present invention, which are illustrated in the accompanying drawings, in which like numerals designate like elements.

Referring to FIG. 2, there is illustrated a binocular head-mounted display 1 according to one embodiment of the present invention, which includes a frame 30 and two imaging apparatuses 10 and 20. The frame 30 is wearable on a use's head (not shown), and the imaging apparatuses 10 and 20 are respectively integrated on the frame 30 and can respectively form two virtual images LI and RI in front of the left and right eyes of the user.

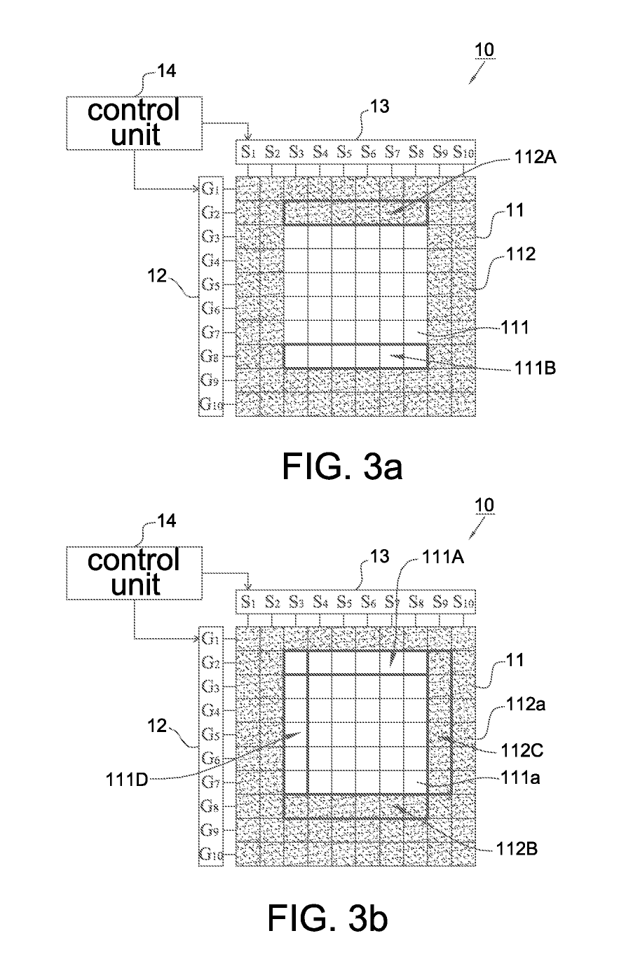

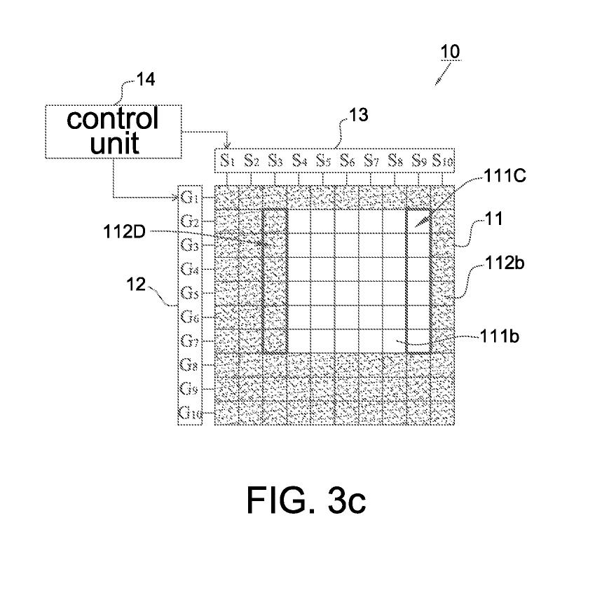

Referring to FIGS. 3a to 3c, there are shown schematic diagrams of the imaging apparatuses 10 and 20 according to the embodiment of the present invention. Since the structures and the operating principles of the imaging apparatus 20 are identical to that of the imaging apparatus 10, the detailed description hereinafter will be only focused on the imaging apparatus 10.

The imaging apparatus 10 includes a display unit 11, a gate driver 12, a source driver 13 and a control unit 14. The imaging apparatus 10 further includes an optical engine (not shown) disposed in the optical path. One embodiment of the display unit 11 includes a liquid crystal display panel (LCD panel) and an LCOS panel (Liquid Crystal on Silicon panel). The display unit 11 has a plurality of pixels arranged in matrix and the total number of the pixels is larger than the number of the pixels actually used for showing pictures, which will be referred to as “display pixels” hereinafter, during operation. In this embodiment, it can be implemented by setting part of the pixels in the matrix as display pixels and the rest of the pixels as non-display pixels. For example, as shown in FIGS. 3a to 3c, the blank areas on the display unit 11 are set as display pixels 111, 111a and 111b, and the rest areas (shown with dots) are set as non-display pixels 112, 112a and 112b. The non-display pixels 112, 112a and 112b are preferably driven by dark gray level while the imaging apparatus 10 is under operation so as to prevent chromatic aberration between the display pixels 111, 111a and 111b and the non-display pixels 112, 112a and 112b.

It should be noted that in FIGS. 3a to 3c, a 10×10 pixel matrix is exemplarily given to represent a display screen of the display unit 10 for simplification, wherein each small square denotes a pixel. However, in practical use, the number of the pixels is determined by the resolution of the display unit 11. During initial setup, the display pixels 111 are preferably set in the central area, shown as the blank area in FIG. 3a, of the display unit 10 so to be used as an area for displaying pictures, and the non-display pixels 112 are preferably set to surround the display pixels 111, shown as the area with dots in FIG. 3a, of the display unit 10, such that the display area formed by display pixels 111 can be scrolled to move upward, downward, rightward and leftward.

The gate driver 12 is electrically connected to each row of the display pixels 111 and the non-display pixels 112 for electrically connecting gates of the transistors in the display pixels 111 and the non-display pixels 112 so as to control the ON/OFF states of the transistors (not shown), and the source driver 13 is electrically connected to each column of the display pixels 111 and the non-display pixels 112 for electrically connecting sources of the transistors in the display pixels 111 and the non-display pixels 112 so as to input frame information to them while the transistors turning on. Since the operating principles of the gate driver 12 and the source driver 13 are not the dominant aspect of the present invention, their detailed description will not be described herein.

The control unit 14 is electrically connected to the gate driver 12 and the source driver 13. One embodiment of the control unit 14 is a timing controller (Tcon) which controls image signals inputted into the gate driver 12 and the source driver 13 and further controls the operations of the display pixels 111 and the non-display pixels 112. The control signals from the control unit 14 can control the gate driver 12 to drive some pixels in at least one row (as indicated as 112A) of the non-display pixels 112 which are adjacent to the display pixels 111 to be transferred to display pixels (as indicated as 111A), and can simultaneously drive some pixels in at least one row (as indicated as 111B) of the display pixels 111 which are adjacent to the non-display pixels 112 to be transferred to the non-display pixels (as indicated as 112B). With the same way, the control signals from the control unit 14 can control the source driver 13 to drive some pixels in at least one column (as indicated as 112C) of the non-display pixels 112 which are adjacent to the display pixels 111 to be transferred to display pixels (as indicated as 111C), and can simultaneously drive some pixels in at least one column (as indicated as 111D) of the display pixels 111 which are adjacent to the non-display pixels 112 to be transferred as the non-display pixels (as indicated as 112D). Accordingly, the display area can be longitudinally and/or transversely scrolled on the display unit 11. The detailed operations will be further illustrated in the following paragraphs.

Referring to FIGS. 3a to 3c again, there is shown a position adjusting method of the display area on the display unit 11 according to the embodiment of the present invention. Before the adjustment is performed, picture information is sent to the gate driver 12 and the source driver 13 from the control unit 14 and the picture will be displayed by the display pixels 111 (display area) on the display unit 11, as shown in FIG. 3a. If it is desired to adjust the position of the display area on the display unit 11, the control unit 14 can be utilized to select the desired position of the display area on the display unit 11 by means of controlling the gate driver 12 and the source driver 13. For instance, if the display area is moved upward by one row, then the display area is changed to the display pixels 111a and the rest pixels form the non-display pixels 112a, as shown in FIG. 3b. For example, if the display area is further moved rightward by one column, then the display area is changed to the display pixels 111b and the rest pixels form the non-display pixels 112b, as shown in FIG. 3c. In this manner, according to the embodiment of the present invention, the positions of the displaying pictures on the display unit 11 can be arbitrarily moved upward, downward, rightward and leftward by the scrolling method as described above.

In addition, in an alternative embodiment of the present invention, only one control unit is utilized for simultaneously controlling positions of the display areas on the display units 11 of the imaging apparatuses 10 and 20. Furthermore, the image adjustment can be achieved by controlling only one of the imaging apparatuses 10 or 20 and fixing the position of the display area on the other uncontrolled imaging apparatus. Both methods can be utilized to adjust two virtual images LI and RI respectively formed in front of the left and right eyes of a user to coincide with each other.

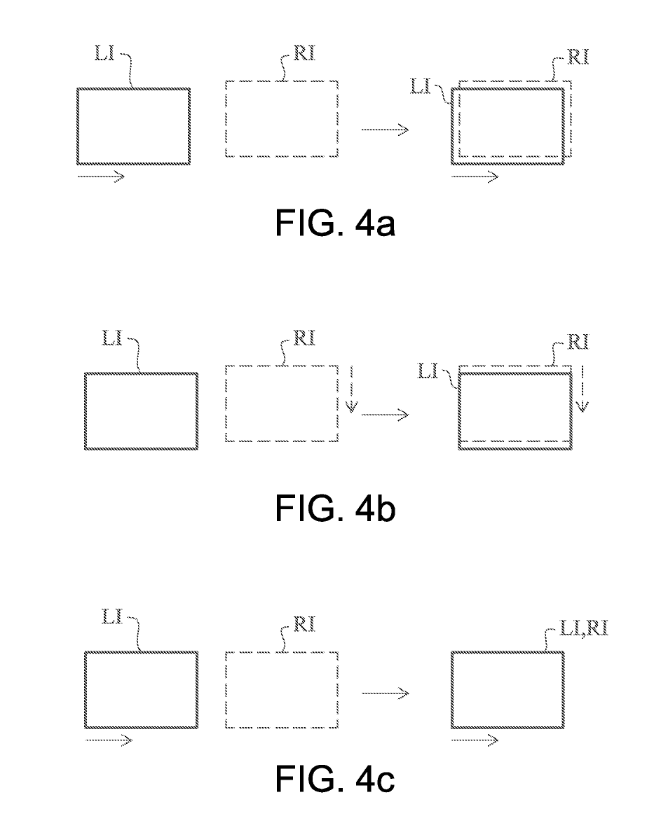

Referring to FIGS. 4a to 4c, there are shown a virtual image adjustment method for a binocular head-mounted display according to the embodiment of the present invention. The binocular head-mounted display 1 is able to form two virtual images LI and RI respectively in front of the left and right eyes of a user (non shown), wherein LI represents a virtual image formed corresponding to the left eye of a user (shown by a solid rectangular) and RI represents a virtual image formed corresponding to the right eye of a user (shown by a dotted rectangular), as shown in FIG. 4a. Before the image adjustment is performed, the virtual images LI and RI seen by the user do not coincide with each other; therefore, it is necessary to adjust the positions of the virtual images LI and RI substantially coincidence to a degree that the user can endure. At first, adjust the position of the display area on the display unit 11 through the method as shown in FIGS. 3b and 3c, therefore, its corresponding virtual image LI can be scrolled rightward so as to form virtual images shown in FIG. 4b, wherein the transverse displacement between the virtual images LI and RI are eliminated. It should be noted that, in the description of this embodiment, the scrolling direction, seen from the user, of the display area on the display unit 11 is assumed to be identical to the moving direction of the virtual image LI. In other embodiment, the scrolling direction of the display area on the display unit 11 can be designed to opposite to the moving direction of the virtual image LI. The scrolling direction of the display area is determined by different optical mechanism design. Next, adjust the position of the display area on the imaging apparatus 20 through the method shown in FIGS. 3a and 3b; therefore, its corresponding virtual image RI can be scrolled downward so as to form virtual images shown in FIG. 4c. In this manner, the virtual images LI and RI formed in front of the left and right eyes of the user can be adjusted to substantially coincide with each other to an acceptable degree.

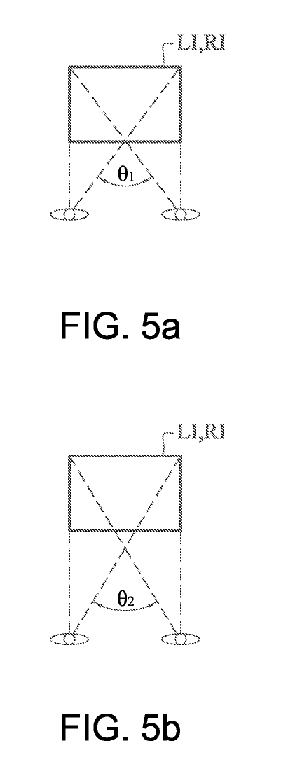

Referring to FIGS. 5a and 5b, there are shown a method to adjust the virtual image plane where the virtual images LI and RI overlap according to the embodiment of the present invention. After the transverse and longitudinal displacements are eliminated by using the above mentioned steps, a user can further respectively tune the positions of the virtual images LI and RI slightly rightward and/or leftward through scrolling, as the way shown in FIG. 4a, then the virtual image plane can be adjusted to near to or far from the eyes of the user until the user feel comfortable to see the virtual images. For example, as shown in FIG. 5a, assuming θ₁ indicates a convergence angle of a virtual image formed in a predetermined distance from the eyes of the user, e.g. 3 meters. After the displacements between the virtual images LI and RI are eliminated, the user probably feels uncomfortable to see the virtual image within this convergence angle. Then the user can use the image adjustment method of the present invention to respectively tune the positions of virtual images LI and RI slightly rightward or leftward so as to obtain the virtual images shown in FIG. 5b, wherein the convergence angle is changed from θ₁ to θ₂ and the user may feel more comfortable to see the virtual image within this convergence angle. If θ₂<θ₁, the virtual image plane is larger than 3 meters; on the contrary, if θ₂>θ₁, the virtual image plane is smaller than 3 meters. Generally, the virtual image plane is preferably varied in accordance with different users, and by using the image adjustment method of the present invention, a user can tune the formed virtual image at a desired position from his eyes till he feels comfortable.

As shown above, an additional mechanical adjustment mechanism has to be added to the conventional binocular head-mounted display so as to adjust the position of the virtual image. However, the method will increase the total weight and the complexity of the optical engine of the display device, thereby causing burden to a user while using it and increasing the manufacturing cost. Compared with the conventional device, the binocular head-mounted display according to the present invention, as shown in FIGS. 2 and 3a to 3c, the position adjustment of the virtual image can be implemented through circuit designs, which can decrease the complexity and the manufacturing cost of the display. Furthermore, the position of the virtual image plane can be tuned to a desired position by a user so as to increase using comfort.

Although the invention has been explained in relation to its preferred embodiments, it is not used to limit the invention. It is to be understood that many other possible modifications and variations can be made by those skilled in the art without departing from the spirit and scope of the invention as hereinafter claimed.

What is claimed is:

1. A head mounted display, comprising:
a frame wearable on a user's head; and
a first imaging apparatus and a second imaging apparatus respectively integrated on the frame, each imaging apparatus comprising:
a display unit having a plurality of pixels arranged in matrix; and
a control unit for selectively setting a part of the pixels as display pixels and the rest of the pixels as non-display pixels, thereby determining the position of a display area on the display unit.

2. The head mounted display as claimed in claim 1, wherein the control units control the pixels through a gate driver and a source driver.

3. The head mounted display as claimed in claim 1, wherein the first imaging apparatus generates a first virtual image while the second imaging apparatus generates a second virtual image; and the first and the second virtual images can be adjusted to substantially coincide with each other by adjusting the positions of the display areas on the first and the second imaging apparatuses.

4. The head mounted display as claimed in claim 3, wherein the control unit of the first imaging apparatus controls the position of the display area thereof to make longitudinal movement and the control unit of the second imaging apparatus controls the position of the display area thereof to make transverse movement.

5. The head mounted display as claimed in claim 1, wherein the display units are LCD panels or LCOS panels.

6. The head mounted display as claimed in claim 1, wherein the non-display pixels are driven by dark gray level.

7. A head mounted display, comprising:
a frame wearable on a user's head;
a first imaging apparatus having a display unit with a plurality of pixels arranged in matrix;
a second imaging apparatus having a display unit with a plurality of pixels arranged in matrix; and
a control unit for selectively setting a part of the pixels of the display units as display pixels and the rest of the pixels of the display units as non-display pixels, thereby determining the positions of display areas on the display units.

8. The head mounted display as claimed in claim 7, wherein the control unit controls the pixels through a gate driver and a source driver.

9. The head mounted display as claimed in claim 7, wherein the first imaging apparatus generates a first virtual image while the second imaging apparatus generates a second virtual image; and the first and the second virtual images can be adjusted to substantially coincide with each other by adjusting the positions of the display areas on the first and the second imaging apparatuses.

10. The head mounted display as claimed in claim 9, wherein the control unit controls the position of the display area on the first imaging apparatus to make longitudinal movement and controls the position of the display area on the second imaging apparatus to make transverse movement.

11. The head mounted display as claimed in claim 7, wherein the first imaging apparatus generates a first virtual image while the second imaging apparatus generates a second virtual image; and the first and the second virtual images can be adjusted to substantially coincide with each other by adjusting the position of the display area on the first imaging apparatus.

12. The head mounted display as claimed in claim 7, wherein the display units are LCD panels or LCOS panels.

13. The head mounted display as claimed in claim 7, wherein the non-display pixels are driven by dark gray level.

14. An image adjustment method for a head mounted display, comprising the steps of:
providing a first imaging apparatus having a plurality of pixels arranged in matrix for generating a first virtual image;
providing a second imaging apparatus having a plurality of pixels arranged in matrix for generating a second virtual image; and
selectively setting a part of the pixels as display pixels and the rest of the pixels as non-display pixels, thereby respectively determining the positions of display areas on the first and the second imaging apparatuses.

15. The image adjustment method as claimed in claim 14, further comprising the step of:
controlling the positions of the display areas on the first and the second imaging apparatuses so as to adjust the first and the second virtual images substantially coincide with each other.

16. The image adjustment method as claimed in claim 15, further comprising the step of:
providing at least one control unit to control the positions of the display areas on the first and the second imaging apparatuses.

17. The image adjustment method as claimed in claim 16, wherein the position of the display area on the first imaging apparatus is controlled to make longitudinal movement while the position of the display area on the second imaging apparatus is controlled to make transverse movement.

18. The image adjustment method as claimed in claim 16, wherein the position of the display area on the first imaging apparatus is controlled to make longitudinal and transverse movement while the position of the display area on the second imaging apparatus is fixed.

19. The image adjustment method as claimed in claim 14, wherein the non-display pixels are driven by dark gray level.

20. The image adjustment method as claimed in claim 16, wherein the control unit controls the pixels through a gate driver and a source driver.
